(19) United States
(12) Patent Application Publication
(10) Pub. No.: US 2014/0143278 A1
(43) Pub. Date: May 22, 2014

(54) APPLICATION PROGRAMMING INTERFACE LAYERS FOR ANALYTICAL APPLICATIONS

(71) Applicants: Karl-Peter Nos, Nussloch (DE); Martin Gembalzyk, Eppelheim (DE)

(72) Inventors: Karl-Peter Nos, Nussloch (DE); Martin Gembalzyk, Eppelheim (DE)

(21) Appl. No.: 13/679,726

(22) Filed: Nov. 16, 2012

(51) Int. Cl. G06F 17/30

(52) U.S. Cl. 707/781; 707/E17.005

(57) ABSTRACT

A system for accessing analytical data for external use may include a database storing a first data set and a second data set. The first data set and the second data set may include analytical data. A first access layer may provide access to a first data set from the database and a second access layer may provide access to a second data set from the database. A first application programming interface may provide functions to access the first access layer and a second application programming interface may provide functions to access the second access layer. The first application programming interface may be configured to receive a request via the first access layer to access the first data set from the database and the second application programming interface may be configured to receive a request via the second access layer.

### BACKGROUND

Companies and organizations use analytical data to make daily decisions. Analytical applications can harness such data from various sources and provide methods to process and provide reports using the data. The data may be stored in a centralized database that can be used together with other sources of data to provide analytical reports. The request for the analytical data can be made by analytical applications.

Typically, analytical applications offer only one way to access the data. The applications are specialized with functions by the consumers to expose the data. However, for different use cases and performance requirements it is needed to have harmonized access options for the different technology layers of an analytical infrastructure.

Business Intelligence Consumer Services (BICS) is an example of an infrastructure that can be used to expose analytical data. However, BICS uses one framework to access the analytical data and it is not possible to add additional application programming interface implementations of BICS to connect another framework to BICS consumers. This is because each BICS consumer decides which BICS provider implementation is used. Furthermore, there is no common subset of functions because each user has only specialized shortcuts to get access to the data not exposed by BICS.

The BICS infrastructure and the specialized shortcuts provide limited options to access the database. The BICS infrastructure and the specialized shortcuts do not allow users to fully utilize all of the access layers available in the analytical infrastructure. That is, the BICS infrastructure and the specialized shortcuts do not provide users easy access to different types of data in the database and/or to access the data in a different ways.

### BRIEF DESCRIPTION OF THE DRAWINGS

The accompanying drawings illustrate the present disclosure and, together with the description, further serve to explain the principles of the various embodiments and to enable one skilled in the pertinent art to make and use the embodiments.

FIG. 1 is a block diagram of an exemplary computer system including a database and a plurality of access layers.

FIG. 2 illustrates an embodiment of a process for accessing analytical data in a database.

FIG. 3 is a system block diagram of a system using multiple access layers.

FIG. 4 is a block diagram of an exemplary computer system.

### DETAILED DESCRIPTION

Embodiments of the present disclosure are directed to methods and systems for providing each access layer of an analytical system one or more application programming interfaces. The configuration allows for the analytical data to be efficiently accessed from a database in the analytical system. Even though the access layers may have different performance requirements, external applications can access the analytical data.

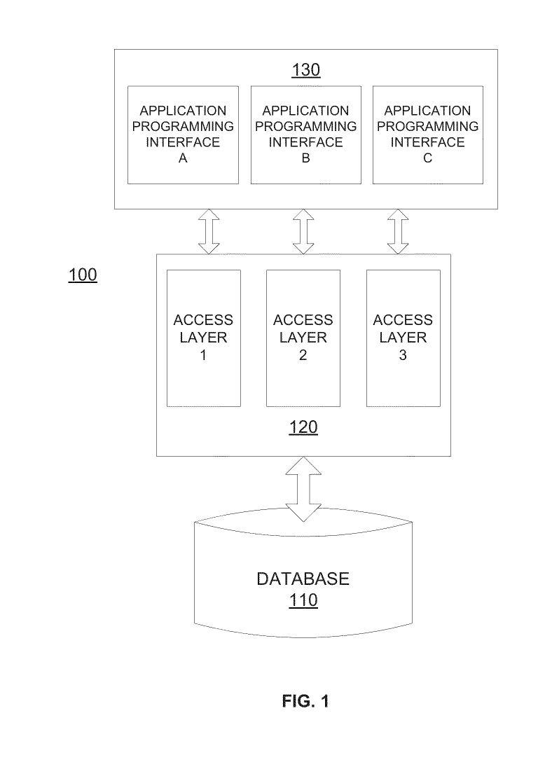

FIG. 1 is a block diagram of an exemplary computer system 100 including a database and a plurality of access layers. The system may include a database 110, access layers 120 and application programming interfaces 130. Each access layer 120 may be controlled by one or more application programming interfaces 130. In one embodiment, each access layer 120 is controlled by a different application programming interface 130 or a different set of application programming interfaces 130. The application programming interfaces 130 may be controlled by users, such as system administrators, customers or consultants.

The database 110 may store analytical data (e.g., data, instructions and metadata).

The database may include different sets of data (e.g., first data set and a second data set) and the sets of data may including analytical data. The database 110 may be a storage device having a multi-dimensional storage structure. The database 110 may be a relational database, and/or an in-memory database allowing for in-memory storage or in-memory computation. The database 110 may include models on how to access the data in the database 110. The models may include information models (e.g., business models) or calculation models. The information models may include analytical views and/or calculation views. Thus, the first data set and the second data set may include data for analytical reports and models for accessing the data.

Database 110 may be SAP HANA™ database. HANA software may be used for in-memory computing. HANA software can allow users to instantaneously access, explore, model and analyze data in real time, without impacting existing applications or systems. HANA views can be used for analytical views. Generation of HANA views can be made from multi dimensional analytical views.

The one or more access layers 120 may be used to access the database to retrieve, modify and/or store data in the database 110. The access layers 120 may be used to access the same or different data in the database 110 (e.g., a first access layer may provide access to a first data set and a second access layer may provide access to a second data set). The access layers 120 provide for the analytical data in the databases to be accessed in different ways based on different use cases and/or performance requirements for accessing the data in the database 110. The access layers 120 may correspond to different technology layers of an analytical infrastructure.

The access layers 120 may be used for reporting and/or analytics purposes. Each access layer 120 may access the database 110 differently. The access layers 120 may have varying degree of access to the data in the database 110 or to particular portions of the data, analytical views, and/or models stored in the database 110. For example, a first access layer may provide a first degree of access to the database and the second access layer may provide a second degree of access to the database. The degree of access may depend on a user who initiates a request to an access layer. A particular access layer may have full authorization to access and edit the data or models in the database 110. Another access layer 120 may be limited only to read the data or models in the database 110 or the access layer 120 may be limited to executing certain functions in the database 110.

Each of the access layers 120 may access different types of data in the database 110. For example, one access layer may have access to directly access database views, another access layer may have access to directly access the raw data (i.e., data sources) and another access layer may have access to the reports with full authorization or with limited authorization.

The degree of access or the type of access of the layer 120 may be based on the purpose of the layer 120 and/or the user or entity using the layer 120 or one or more of the application programming interfaces 130. The degree of access or the type of access of the layer 120 may be based on the infrastructure of the analytical infrastructure and the database 110. BICS may be one of the access layers used to access the analytical data in the database 110.

The layers 120 may be configured to manage data or models which are stored locally or remotely in any number of databases or storage devices. The access layers 120 may be designed to perform specific operations involving the information in the database. For example, the access layer 120 may be configured to provide a report that involves accessing data from the database 120 and storing the report in the database 120. The access layer 120 may be a data management layer that manages the retrieval of data, storage of data and querying data stored in the database 120. The data management layer may be configured to access a multi-dimensional storage structure and/or a storage device or database in which a multi-dimensional storage structure is stored. As used herein a “multi-dimensional storage structure” can refer to a data source with data organized by at least two types of relational tables, dimensional tables and measure tables (e.g., fact tables), where dimensional tables contain categorical data and measure tables contain numerical data and the two types of tables are correlated via foreign keys.

The application programming interface 130 may provide a dedicated set of functions for the access layer 120. The functions may be used to access analytical data from the database 110 for external usage. For example, the application programming interface 130 may be used to connect data source (e. g., database 110) to a central data warehouse. The application programming interface 130 may provide options, which can be accessed by external tools, to generate analytical views of information in the database 110. Thus, the application programming interface 130 may provide an access layer 120 that can be accessed by external tools for data retrieval. Each access layer 120 may be associated with a set of application programming interfaces 130 and each access layer may be associated with a different set of application programming interfaces 130, allowing for the analytical views to be generated in a stable way.

For example, a first application programming interface may provide functions to access the first layer, and a second application programming interface may provide functions to access the second access layer. The first access layer providing access to a first data set and the second access layer providing access to a second data set. The data sets retrieved via the functions of the first application programming interface and via the functions of the second application programming interface may be distinct data sets or the same data sets provided in a different format. The first application programming interface may provide a first analytical view of the first data set and the second application programming interface may provide a second analytical view of the second data set.

The application programming interface 130 may provide for stateless access. In stateless access the content may be available for the lifetime of the request and may be released at the end of the request. Web services with specialized dashboards or web pages may use stateless access. With stateless access the data and objects held by the application request may be released, allowing for the lifetime of the application object to be from the time of the request to the time when the response is sent. ODATA implementation may be used to enable stateless lightweight user interfaces.

Each layer 120 may receive multiple types of commands from one or more application programming interfaces 130 that process database requests and support execution of custom application operations. The request to access the database may be received via the access layers. Each application programming interface may be configured to receive a request via one or more of the access layers. For example, a first application programming interface may be configured to receive a request via the first access layer to access a first data set from the database. Similarly, the second application programming interface may be configured to receive a request via the second access layer to access a second data set from the database. The first and second application programming interface may be configured to receive requests via the same access layer or via different the same access layer. In addition, the same application programming interface may be configured to receive a request via multiple access layers (e.g., first application programming interface configured to receive requests via the first access layer and the second access layer). Embodiments may support multiple different applications with different custom application operations executing the different custom application operations in the same database.

A universal application programming interface 130 may be used to generate a report (e.g., analytical view or analytical report based on analytical views). The parameters for the report may be saved each time the application programming interface 130 is accessed. An access database can be created based on the access to the database. The parameters may be used on subsequent request to generate a report. The parameters used in the report may be associated with the user generating the report. The embodiments provide for the reports to be generated in a stable manner even when changes are made to the layers or the database. If the software is updated, the changes can be reported in the database such that when subsequent report is generated based on previous report, the new report can be generated in a stable matter. The new report, using the previous application programming interface 130 options, can use the updated information provided in the database 110.

As discussed above, options in the application programming interface 130 can be used to generate a specific report. Once a report is generated, the options that are not utilized can be removed from the application programming interface 130. Options previously selected in the application programming interface 130 may be used to generate subsequent reports. The report parameters (e.g., definitions) may be stored in the database 110. Accordingly, the application programming interfaces 130 can access the reporting functions and the data associated with the report for external implementation. Unlike specialized shortcuts, the application programming interface 130 may allow for the user to customize the functions used to access the data in the database 110 via the access layers 120.

Providing each of the layers a different set of application programming interface 130 may allow for the application programming interface 130 to connect data sources as operational data provisioning (ODP) to the database. The operational data provisioning may define a set of interfaces for data that is classified as transaction data or master data (attributes, texts, or hierarchies). The operational data provisioning may expose transaction and master data including their associations to the analytic query (e.g., transient provider) and enable the access to data for reporting/analytics purposes as well as for mass data replication. The operational data provisioning may access the multi dimensional analytical views for data retrieval across the system.

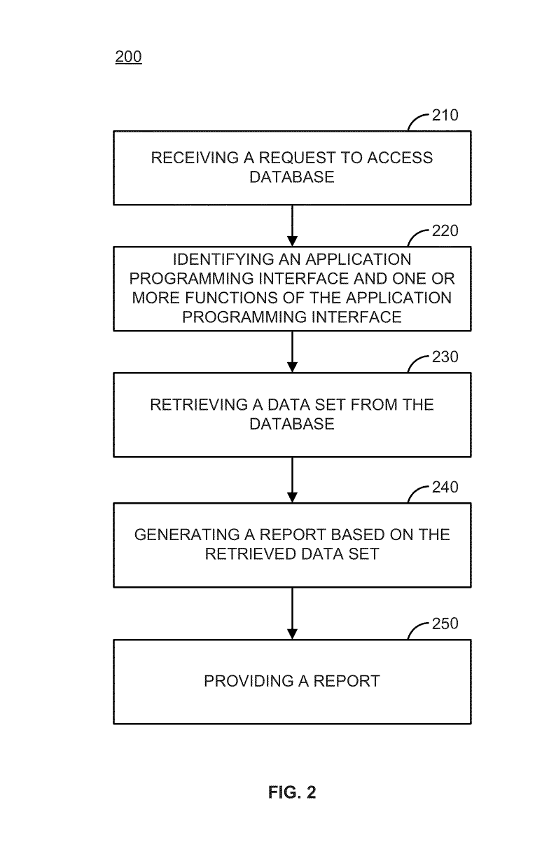

FIG. 2 illustrates an embodiment of a process 200 for accessing analytical data in a database. The process may include, receiving a request from a requestor to access a data set from the database 210, identifying an application programming interface and one or more functions of the application programming interface based on the request 220, retrieving the data set from the database 230, generating a report based on the retrieved data set 240, and providing the report 250.

The request from a requestor to access a data set from the database 210 may be received at one of the available access layers. The request may be processed by an external application. For example, a request from a requestor to access a data set from the database may be received at the first access layer. Multiple requests can be received from the same access layer or from different access layers. For example, one request can be received at the first access layer and another request can be received at the second access layer. Each of the access layers may access different data and/or different types of data in the database. The layers may manage data or models which are stored locally or remotely in a plurality of databases or storage devices.

Based on the request, an application programming interface and one or more functions of the application programming interface may be identified 220. The application programming interface may be associated with the access layer used to receive the request. Each access layer may be associated with one or more application programming interfaces. Each access layer in the analytical system may be associated with at least one application programming interface.

A request at a first access layer may be used to identify multiple application programming interfaces (e.g., a first application programming interface and a second application programming interface). For each application programming interface one or more functions of the respective application programming interface can also be identified. Data sets from the database can be retrieved via the identified one or more functions of the respective application programming interface and the first access layer. The second application programming interface and the one or more functions of the second application programming interface may be identified in response to a message from a function of the first application programming interface. The data sets retrieved via the functions of the first application programming interface and via the functions of the second application programming interface may be different data sets or the same data sets provided in a different format.

The one or more data set from the database may be retrieved 230 via the identified functions of the application programming interface and the respective access layer (e.g., first access layer and/or the second access layer). Before the report is generated, the report definitions may be retrieved from the database. Retrieving the report definitions may include retrieving data associated with the report definitions (e.g., corresponding data and connection details from where the data is gathered).

The report may be generated 240 based on the retrieved data set. More than one data sets may be used to generate the report. For example, the data set retrieved from the database via the functions from the first application programming interface and the data set retrieved from the database via the functions from the second application programming interface may be used to generate the report. The request may include report definitions which may be used to generate the report. Thus, the report may be based in part on the report definitions. The report may be generated in response to a user selecting an option to generate the report, in response to a request from an external application or after the options are selected in the application programming interface. The report can be generated at the time the options are selected to preview the report and/or before the report definitions are stored in the database. Generating the report may include retrieving additional analytical data from the database.

After the report is generated, the report may be provided to the requester 250. The report may be provided to the requestor in response to the request. Providing the report to the requester may include storing the report in a designated storage space, the database, providing a link to the requester with where the report is stored, displaying the report to the requester or individuals designated by the requester.

When multiple requests are received at different access layers, one or more functions of the same or different application programming interfaces may be identified. For example, a request at a first access layer may be used to identify a first application programming interface and one or more functions of the first application programming interface. This request at the first access layer may also be used to identify a second application programming interface and one or more functions of the second application programming interface. A request at a second access layer may be used to identify a third application programming interface and one or more functions of the third application programming interface. For each request, a respective data set may be retrieved via the identified functions. For example, a first data set may be retrieved from the database via the identified one or more functions of the first and/or second application programming interfaces and the first access layer. A second data set may be retrieved from the database via the identified one or more functions of the third application programming interface and the second access layer. The first data sets and the second data set may be distinct data sets or the same data sets provided in a different formats.

The report may be generated based on the one or more of the first data set and the second data set. Distinct report may be generated for each of the data sets. A first report may be generated using the first data set and a second report may be generated using the second data set. Each report may be correspond to different analytical views. For example, the first report may correspond to a first analytical view and the second report may correspond to a second analytical view.

The requests may identify a user. The user may be the requester or another user authorizing the request. The user may have different access privileges to the data in the database and/or the function of the application programming interfaces. When the request identifies a user, the application programming interface may be identified based in part on the access privileged of the identified user.

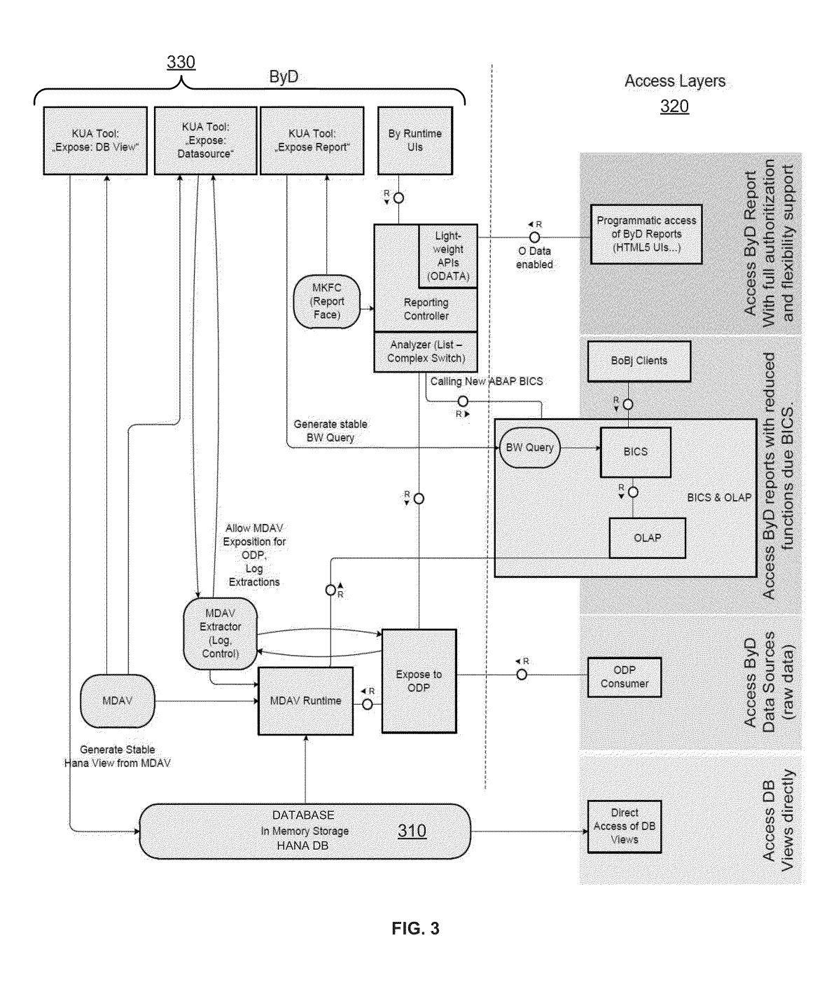

FIG. 3 is a system block diagram 300 of a system using multiple access layers. The system 300 may include database 310, a plurality of access layers 320, and application programming interfaces 330. The access layers may include access ByDesign report with full authorization and flexibility support, access business ByDesign report with reduced functions, access ByDesign data sources (e.g., raw data), and access database views directly. As shown in FIG. 3, each layer may access the database 310 differently and may have its own performance requirements.

The application programming interfaces 330 may include Key User Analytics (KUA) tools and a runtime user interface. The KUA tool can be used to create copies of reports (e.g., ByDesign reports) that can be exposed to customer defined functions (e.g., BADI). As discussed above, each access layers 320 may have one or more application programming interfaces 330 that can be controlled by a user.

Multi dimensional analytical view (MDAV) can be used to generate reports for future use and HANA view. The reports may be considered as new entities with their own assignment. These reports and HANA views can be stored in the database. At runtime, an MDAV executer (e.g., a MDAV runtime engine) may run a distributed and optimized provisioning of reporting and analytics data.

Some embodiments of the disclosure may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some examples may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the disclosure may be implemented using Java, C++, or other object-oriented programming language and development tools. Another embodiment may be implemented in hard-wired circuitry in place of, or in combination with machine readable software instructions.

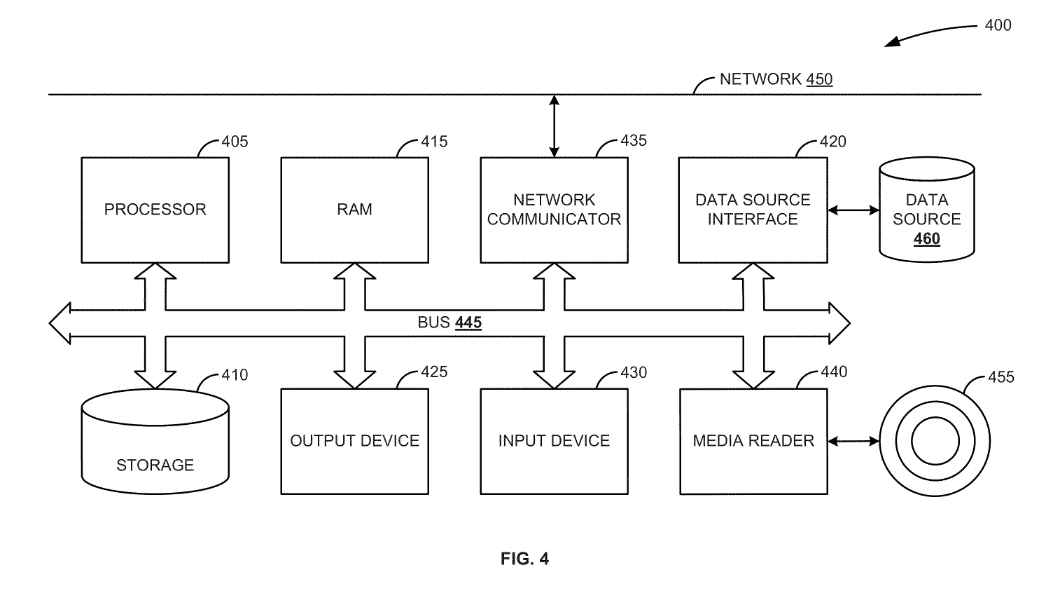

FIG. 4 is a block diagram of an exemplary computer system 400. The computer system 400 includes a processor 405 that executes software instructions or code stored on a computer readable storage medium 455 to perform the above-illustrated methods. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment of the disclosure, the computer system 400 further includes an output device 425 (e.g., a display) to provide at least some of the results of the execution as output including, but not limited to, visual information to users and an input device 430 to provide a user or another device with means for entering data and/or otherwise interact with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445. Computer system 400 includes a data source interface 420 to access data source 560. The data source 460 can be accessed via one or more abstraction layers implemented in hardware or software. For example, the data source 460 may be accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

A semantic layer is an abstraction overlying one or more data sources. It removes the need for a user to master the various subtleties of existing query languages when writing queries. The provided abstraction includes metadata description of the data sources. The metadata can include terms meaningful for a user in place of the logical or physical descriptions used by the data source. For example, common business terms in place of table and column names. These terms can be localized and or domain specific. The layer may include logic associated with the underlying data allowing it to automatically formulate queries for execution against the underlying data sources. The logic includes connection to, structure for, and aspects of the data sources. Some semantic layers can be published, so that it can be shared by many clients and users. Some semantic layers implement security at a granularity corresponding to the underlying data sources' structure or at the semantic layer. The specific forms of semantic layers includes data model objects that describe the underlying data source and define dimensions, attributes and measures with the underlying data. The objects can represent relationships between dimension members, provides calculations associated with the underlying data.

In the above description, numerous specific details are set forth to provide a thorough understanding of embodiments of the disclosure. One skilled in the relevant art will recognize, however that the embodiments of the disclosure can be practiced without one or more of the specific details or with other methods, components, techniques, etc. In other instances, well-known operations or structures are not shown or described in details to avoid obscuring aspects of the disclosure.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the embodiments to the precise forms disclosed. While specific embodiments of, and examples for, the disclosure are described herein for illustrative purposes, various equivalent modifications are possible within the scope of the disclosure, as those skilled in the relevant art will recognize. These modifications can be made to the embodiments in light of the above detailed description. Rather, the scope of the disclosed embodiments is to be determined by the following claims, which are to be interpreted in accordance with established doctrines of claim construction.

We claim:

1. A system for accessing analytical data for external use, comprising:
a database storing a first data set and a second data set, wherein the first data set and the second data set include analytical data;
a first access layer that provides access to a first data set from the database;
a second access layer that provides access to a second data set from the database;
a first application programming interface providing functions to access the first access layer, wherein the first application programming interface is configured to receive a request via the first access layer to access the first data set from the database; and
a second application programming interface providing functions to access the second access layer, wherein the second application programming interface is configured to receive a request via the second access layer.

2. The system of claim 1, wherein the first application programming interface provides a first analytical view of the first data set and the second application programming interface provides a second analytical view of the second data set.

3. The system of claim 1, wherein the first set of data is distinct from the second set of data.

4. The system of claim 1, wherein the database is an in-memory database.

5. The system of claim 1, where the first data set and the second data includes data for analytical reports and models for accessing the data.

6. The system of claim 5 wherein the models include at least one of analytical views and calculation views.

7. The system of claim 1, wherein the first access layer provides a first degree of access to the database and the second access layer provides a second degree of access to the database.

8. The system of claim 1, wherein the first degree of access depends on a user who initiates a request to the first access layer.

9. The system of claim 1, wherein the first access layer is associated with a set of application programming interfaces.

10. The system of claim 1, wherein the first application programming interface and the second application programming interface provide stateless access to the database.

11. A method for accessing analytical data in a database, comprising:
at a first access layer, receiving a request from a requestor to access a data set from the database;
identifying a first application programming interface and one or more functions of the first application programming interface based on the request, wherein the first application programming interface is associated with the first access layer;
retrieving the data set from the database via the identified one or more functions of the first application programming interface and the first access layer;
generating a report based on the retrieved data set; and
providing the report to the requestor.

12. The method of claim 11, further comprising:
identifying a second application programming interface and one or more functions of the second application programming interface; and
retrieving another data set from the database via the identified one or more functions of the second application programming interface and the first access layer.

13. The method of claim 12, wherein the second application programming interface and the one or more functions of the second application programming interface are identified in response to a message from a function of the first application programming interface.

14. The method of claim 12, wherein the report is generated based on the retrieved data set and the another data set.

15. The method of claim 11, further comprising:
at a second access layer, receiving a request to access a second data set from the database;
identifying a third application programming interface and one or more functions of the third application programming interface; and
retrieving the second data set from the database via the identified one or more functions of the third application programming interface and the second access layer, wherein the second data set is distinct from the data set.

16. The method of claim 15, wherein the report is generated based in part on the retrieved second data set.

17. The method of claim 15, further comprising:
generating a second report based on the retrieved second set of data, wherein the report corresponds to a first analytical view and the second report corresponds to a second analytical view.

18. The method of claim 11, wherein the request includes report definitions and wherein the report is based in part on the report definitions.

19. The method of claim 11, wherein the request identifies a user and the first application programming interface is identified based in part on access privileges of the identified user.

20. A non-transitory computer readable medium storing a program causing a computer to execute a process for accessing analytical data in a database, the process comprising:
at a first access layer, receiving a request from a requestor to access a data set from the database;
identifying a first application programming interface and one or more functions of the first application programming interface based on the request, wherein the first application programming interface is associated with the first access layer;
retrieving the data set from the database via the identified one or more functions of the first application programming interface and the first access layer;
generating a report based on the retrieved data set; and
providing the report to the requestor in response to the request.
